(19) United States
(12) Patent Application Publication
(10) Pub. No.: US 2006/0290911 A1
(43) Pub. Date: Dec. 28, 2006

(54) Scanning photolithography apparatus and method

(76) Inventor: Joo-Sung Jung, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/452,230

(22) Filed: Jun. 14, 2006

(30) Foreign Application Priority Data
Jun. 24, 2005 (KR) 2005-55224

(51) Int. Cl. G03B 27/42

(52) U.S. Cl. 355/53; 355/55

(57) ABSTRACT

A reticle having a reticle pattern is mounted with a scanning photolithography apparatus. The reticle pattern adapted to form a circuit pattern on a photoresist layer formed on a substrate. An enlargement ratio for an image pattern associated with the circuit pattern in a scanning direction defined by the scanning photolithography apparatus is different from that associated with a direction perpendicular to the scanning direction.

### BACKGROUND OF THE INVENTION

1. Field of the Invention

Embodiments of the invention relate to a semiconductor manufacturing apparatus and method. More particularly, embodiments of the invention relate to a scanning photolithography apparatus and method.

This application claims priority to Korean Patent Application No. 2005-55224 filed on Jun. 24, 2005, the subject matter of which is hereby incorporated by reference.

2. Description of the Related Art

Various lithographic techniques have been used to generate circuit patterns during the fabrication of semiconductor devices for many decades. Common lithographic techniques use a specially designed exposure apparatus to transfer a pattern formed on a reticle (e.g., a photo mask) onto a substrate, such as a semiconductor wafer, a glass plate, etc. The pattern is typically transferred onto a photo-resist layer formed on the substrate.

Conventionally, a device referred to as a step and repeat stepper has been used as one type of exposure apparatus. In use, the step and repeat stepper optically miniaturizes and projects a reticle or mask pattern onto a first “one shot” region of the substrate. Following exposure the first one shot region, exposure of a next shot region is performed. In this manner, the conventional step and repeat stepper repeatedly projects the pattern across the entire surface of the substrate using multiple exposures.

More recently, an advanced scanning photolithography technique has been used in the fabrication of semiconductor devices. In order to magnify an exposure range of a pattern, a scanning photolithography apparatus restricts light emanating from an illuminating system into a defined slit shape (e.g., a rectangular shape). Additionally, a competent scanning photolithography apparatus synchronously scans the reticle and the wafer in opposite directions in relation to a projection optical system. In this context, the apparatus miniaturizes and projects a portion of the pattern onto the wafer using an exposure light defined by the slit shape.

FIGS. 1 and 2 show a conventional reticle (R). Referring to FIG. 1, a reticle pattern is designed to be about 4 times larger than the circuit pattern ultimately formed on a substrate (e.g., wafer (W)). An enlargement ratio between the reticle pattern and the circuit pattern will be 4:1, and thus a transfer magnification of the reticle pattern onto the wafer will be 1/4 times. Of note, the enlargement ratio in the horizontal direction (i.e., X-axis) is identical to that in the vertical direction(i.e., Y-axis). It is normally desirable to arrange one or more circuit patterns related to a plurality of chips on a reticle. For example, a total of 6 chips are arranged in the example shown in FIG. 1. A one-shot region of wafer (W) to be exposed during the photolithography operation is indicated in FIG. 1 by the bold dotted line.

Referring to FIG. 2, a more specific (and asymmetrical) reticle adapted, for example, to the patterning a storage node poly in a Dynamic Random Access Memory (DRAM) is formed in a very different manner than the symmetrically arranged reticle example of FIG. 1. In the second example, an edge portion of the wafer and a region beyond the edge will be simultaneously exposed. This type of exposure may cause an optical system associated with the exposure equipment to de-focus. Additionally, the storage node poly pattern formed near edge of wafer (W) may become peeled back by the subsequent fabrication processes. This edge peeling may produce contamination particles that reduce yield of the semiconductor devices being fabricated. As shown in FIG. 2, the five (5) chips defined by the reticle pattern may be classified into three (3) separate blocks—one independent chip, two adjacent chips arranged in an up and down (i.e., vertical) direction, and two adjacent chips arranged in a left and right (i.e., lateral) direction. In this regard, vertical and lateral are relative terms. Each of these separate blocks is indicated by a respective bold dotted line. The bold dotted line thus represents the region exposed by a one shot use of the exposure apparatus.

FIGS. 3a to 3e are schematic illustrations of a convention exposure method. Referring to FIGS. 3a to 3e, a scanning photolithography method moves a reticle (R) and a wafer (W) in opposite directions, while a light passes through reticle (R) to illuminate wafer (W) through a projection optical system 13. The movement speed of reticle (R) and wafer (W) are different. These variable movement speeds define in part the enlargement ratio of the ongoing projection. For example, in order to transfer a reticle pattern onto wafer (W) at a 4 times enlargement, the reticle (R) will move at a speed four times greater than wafer (W).

Reticle (R) thus defines a one shot region formed in a scan field of wafer (W). An exposure “dosage” (graphically indicated below wafer (W) in the FIGS. 3a through 3e) is defined by a cumulative total of the optical energy of the exposure light onto wafer (W).

Such a scanning photolithography method allows an exposure field on the projection optical system to be smaller than that of the step and repeat stepper technique, when the reticle pattern of same size is used. As a result, precision of image formation within the exposure field can be improved.

FIGS. 4a and 4b show a conventional 300 mm wafer adapted to the fabrication of a plurality of semiconductor devices (i.e., chips), such as a DRAM comprising a polysilicon storage node. One rectangle in the illustrated example represents a scan field exposed by one shot, including some chips formed on an edge portion of the wafer. In one exemplary application, a normal reticle is used to make 122 separate one shot exposures in order to expose the entire surface of the 300 mm wafer. However, a storage node poly reticle is used to make 366 separate one shot exposures in order to expose the entire surface of the 300 mm wafer, because the storage node poly reticle is composed of two blocks having two adjacent chips and one block having one chip.

Consequently, according to the conventional exposure method, since it takes about several tens of seconds in order to expose the entire wafer, a reduction in the exposure time for the fabrication of a semiconductor device will increase productivity. In the case reticles like the one shown above related to a storage node poly, the number of shots is about 2.5 times greater than a corresponding normal reticle, thereby decreasing the fabrication throughput for the semiconductor and overall productivity.

### SUMMARY OF THE INVENTION

Embodiments of the invention provide a scanning photolithography apparatus and method facilitating increased productivity and reduced overall exposure times. In one aspect, a reticle adapted for use with these embodiments may be designed such that an enlargement ratio in a first direction is different from that of a second direction.

For example, the reticle may be designed such that the enlargement ratio of a direction perpendicular to the scanning direction of the scanning photolithography apparatus is identical to that of the conventional technique. However, the enlargement ratio of the scanning direction for embodiments of the invention is different from that of the conventional technique. In one specific embodiment, this enlargement ration may be half that of the conventional technique. Within the context of this example, since two times more chips than the conventional technique may be exposed by one shot, the number of “steppings” is about a half of the conventional technique, thereby increasing throughput and overall productivity.

Thus, in one embodiment, the invention provides a scanning photolithography apparatus, comprising; an optical system adapted to generate a slit light, a reticle having a reticle pattern adapted to form a circuit pattern on a substrate, a reticle driving unit configured to move the reticle in a first direction, a projection optical system adapted to project an image of the reticle pattern onto the substrate, and a substrate driving unit adapted to move the substrate in a direction opposite the first direction, wherein a transfer magnification for the circuit pattern associated with the first direction is different than a transfer magnification for the circuit pattern associated with a second direction perpendicular to the first direction.

In another embodiment, the invention provides a photolithography method, comprising; preparing a substrate and a reticle having a reticle pattern, passing light through the reticle while moving the reticle in a first direction and simultaneously moving the substrate in a direction opposite the first direction to thereby transfer a pattern image associated with the reticle pattern onto the substrate, wherein a transfer magnification for the pattern image associated with the first direction is different from that associated with a second direction perpendicular to the first direction.

In another embodiment, the invention provides a reticle mounted with a scanning photolithography apparatus and having a reticle pattern adapted to form a circuit pattern on a photoresist layer formed on a substrate, wherein an enlargement ratio for an image pattern associated with the circuit pattern in a scanning direction defined by the scanning photolithography apparatus is different from that associated with a direction perpendicular to the scanning direction.

### BRIEF DESCRIPTION OF THE DRAWINGS

FIGS. 1 and 2 show a conventional reticle (R);

FIGS. 3A to 3E illustrate views explaining a exposure method using the conventional reticle;

FIGS. 4A and 4B show a wafer on which a plurality of chips is exposed using the conventional reticle;

FIG. 5 shows a reticle according to an exemplary embodiment of the present invention;

FIG. 6 shows a reticle according to another exemplary embodiment of the present invention;

FIG. 7 shows a scanning photolithography apparatus according to the present invention;

FIGS. 8A to 8l illustrate views explaining a photolithography method using the scanning photolithography apparatus according to the present invention;

FIGS. 9A and 9B show a wafer onto which a plurality of chips is exposed using the reticle according to the present invention.

### DESCRIPTION OF EXEMPLARY EMBODIMENTS

Several embodiments of the invention will now be described with reference to the accompanying drawings. While the invention is described in the context of these embodiments, those of ordinary skill in the art will recognize that the invention may be variously embodied and that the illustrated embodiments are presented as teaching examples. Thus, invention should not be construed as being limited to only the exemplary embodiments set forth herein. Throughout the description like reference numerals refer to like or similar elements.

In the description of exemplary embodiments that follows, a wafer (e.g., a silicon wafer) is assumed to be the subject substrate. However, other substrate types may be used instead of a conventional wafer. For example, a wafer formed from semiconductor material may be used for a glass plate such as those adapted for use in planar display devices (e.g., LCD, FED and PDP type devices).

The term “enlargement ratio” used throughout refers to a size ratio between a reticle pattern and a circuit pattern ultimately formed on the wafer. The term “transfer magnification” refers to a degree enlargement of an optically projected image of the reticle pattern onto the wafer. Accordingly, the reciprocal of an enlargement ratio is a transfer magnification. The term enlargement ratio is most often used in the context of a description of a reticle, while the term transfer magnification is most often used in the context of describing the photolithography process.

Of note, the contextual meaning of the term transfer magnification may be different from that of a reduction magnification associated with a general optical system comprising one or more lens, for example. This difference accounts for the fact that when an optical system is used alone, a reticle pattern is reduced by a constant magnification in both orthogonally related first and second directions, but when the optical system and the scanning apparatus are used together, the reticle pattern is reduced by different magnification factor in the first direction as compared with the second direction.

According to one embodiment of the invention, the “size” of the transfer magnification is not numerically defined, but instead is defined in relation to the magnification of a reticle pattern image after its transfer. Thus, the transfer magnification of 1/4 times is defined to be larger than a transfer magnification of 1/2 times.

Although embodiments of the invention are described in the context of a transfer magnification of 1/2 times (i.e., an enlargement ratio of 2 to 1) in a scanning direction of the reticle, and the transfer magnification of 1/4 times in the direction perpendicular to the scanning direction, this is merely one example of many possible transfer magnification factors. Practical transfer magnification factors will vary with respective fabrication processes and associated equipment. Thus, the ratio of the scanning direction to the direction perpendicular to the scanning direction may vary.

In the embodiments that follow, an exemplary number of chips (e.g., 6 or 12) is assumed as a working example. Any reasonable number of chips may be implicated in practical embodiments of the invention.

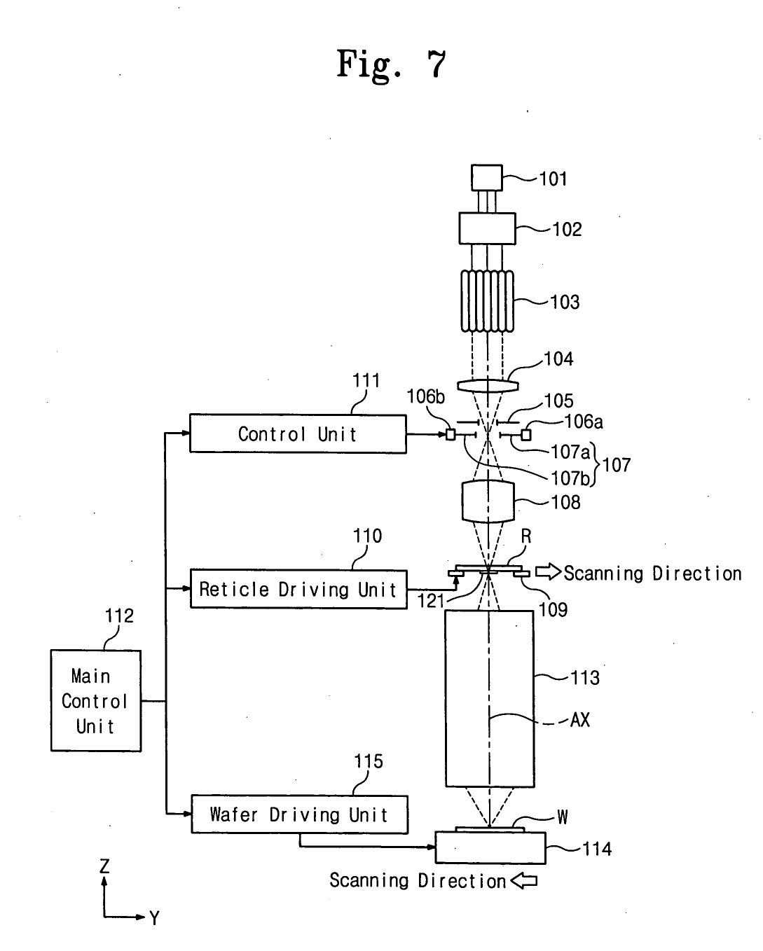

FIG. 5 illustrates a “normal” reticle associated with the fabrication of semiconductor devices according to an embodiment of the invention.

Referring to FIG. 5, the normal reticle is designed so that the respective enlargement ratios relative to a first direction (i.e., a Y-axis or vertical direction) and a second direction (i.e., an X-axis or lateral direction) are different from each other. For example, an enlargement ratio for the first direction (e.g., a direction perpendicular to the scanning direction of an assumed scanning photolithography apparatus) may be 4 to 1, while an enlargement ratio for the second direction (e.g., a direction parallel to the scanning direction) may be 2 to 1. Thus, in the assumed scenario, a transfer magnification associated with the second direction is 1/4 times, while a transfer magnification associated with the first direction is 1/2 times.

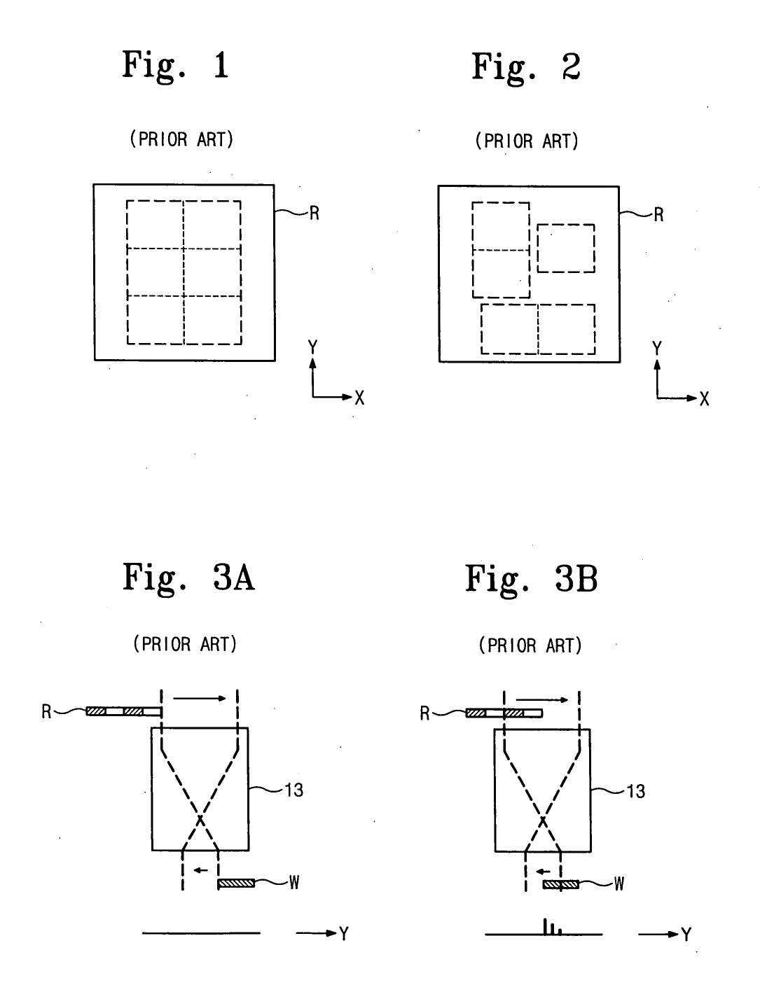

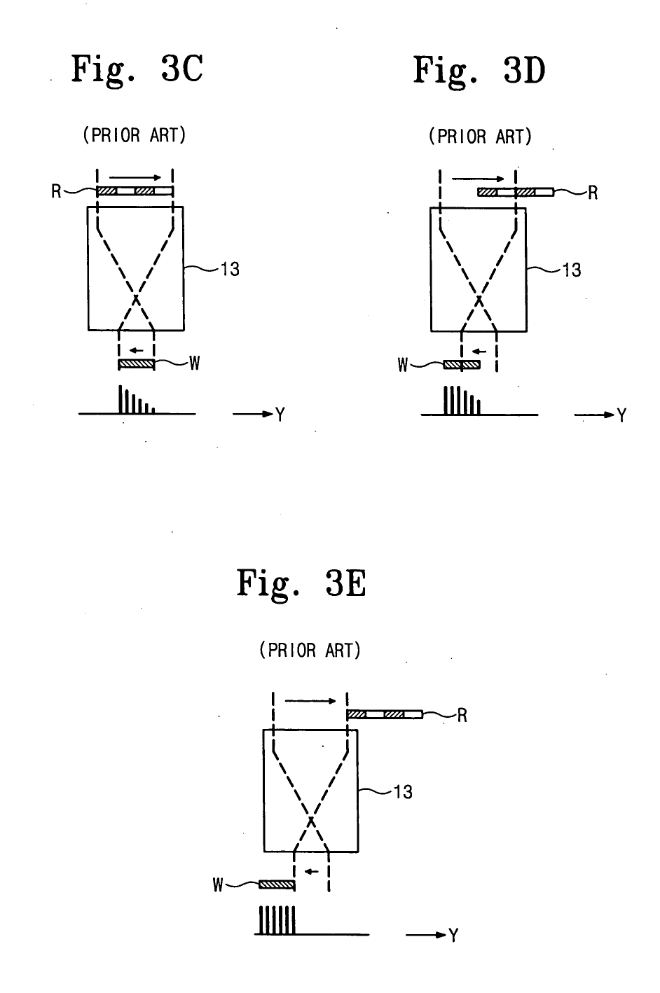

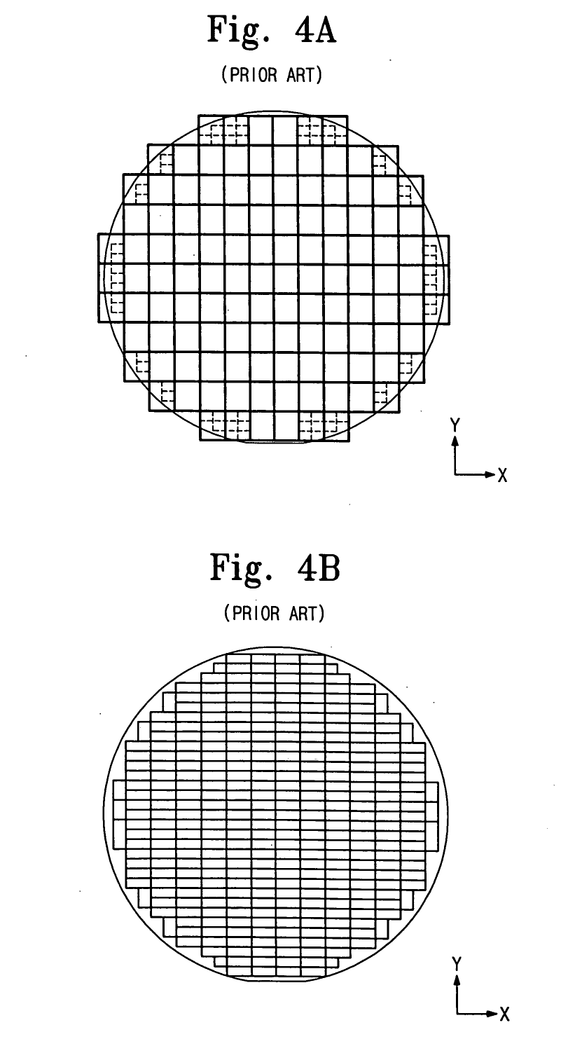

Referring collectively to FIGS. 1 and 5, and all assumptions remaining equal between the conventional example and the illustrated embodiment of the invention, the number of chips defined by an arrangement on a reticle may be increased over that associated with the conventional technique. For example, a total of 12 chips may be arranged on one reticle, as shown in FIG. 5, as opposed to only 6 chips in the conventional example. Here again, a bold dotted line represents a region exposed by one-shot. Thus, 12 chips may be exposed by the same one-shot exposing only 6 chips using the conventional technique.

In illustrated embodiment, since the transfer magnification associated with the first direction is 1/2 times, the movement speed ratio of reticle to wafer should not be 4 to 1 as it is conventionally, but rather 2 to 1. Since the moving speed for the reticle in the illustrated embodiment is twice as slow as the moving speed of the reticle in the conventional example, better control over movement of the reticle may be obtained. Additionally, since a chip area twice as large as the conventional technique may be exposed by the one-shot, the number of “steppings” may be reduced by about half, thereby allowing an increase in throughput and productivity.

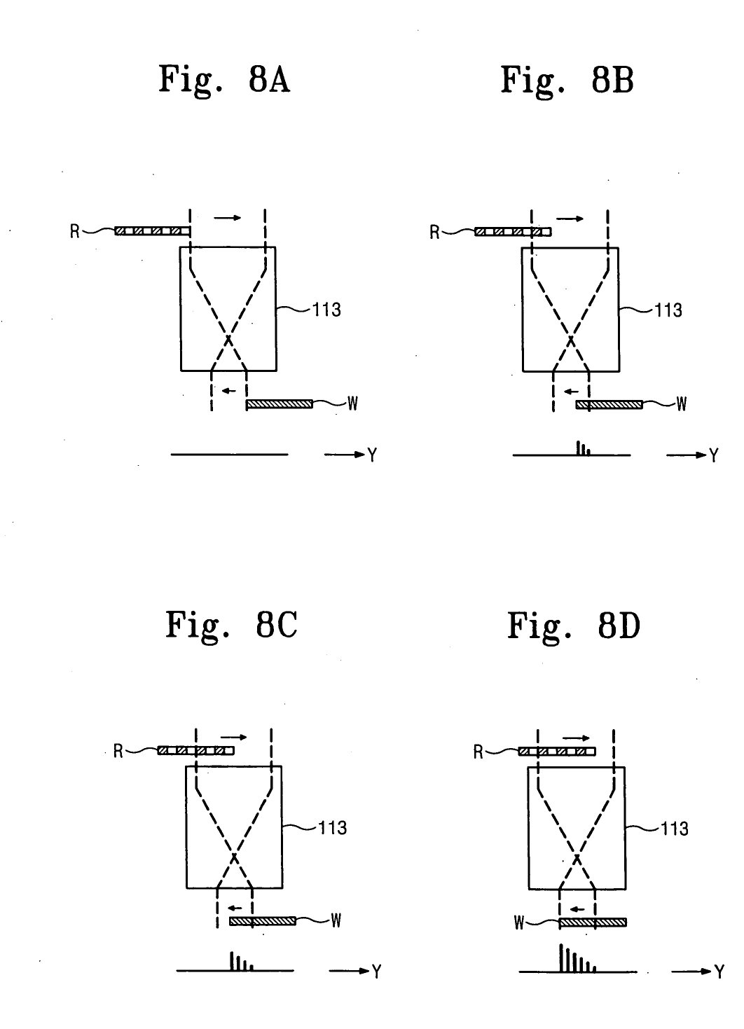

FIG. 6 shows a more specific reticle associated with the patterning of a storage node poly in a DRAM.

Referring to FIG. 6, enlargement ratios for the storage node poly reticle associated with the first and second directions are identical to those described above in relation to FIG. 5. Six chips are arranged on one half portion of the reticle area in one group and may be exposed by the one-shot. Another half portion of the reticle area contains chips arranged in three groups: one independent chip, two adjacent chips arranged in the vertical direction, and two adjacent chips arranged in the lateral direction. As before, the bold dotted lines indicate each block of a region exposed by the one-shot. Accordingly, even when an asymmetric (or complex) reticle associated with a storage node poly is exposed, six chips may be exposed by the one-shot, thereby increasing throughput and productivity.

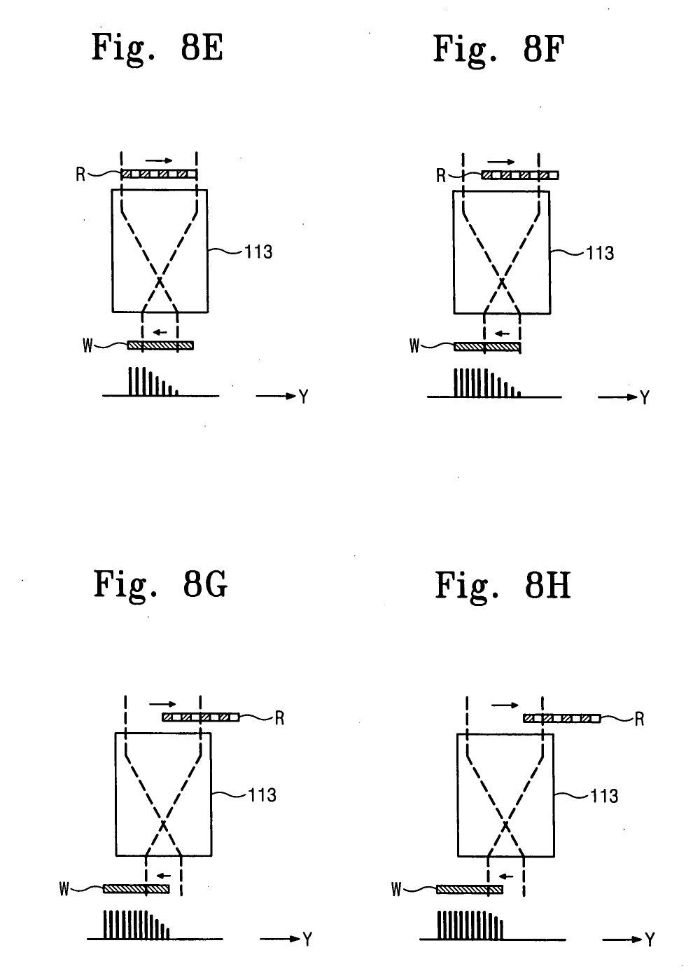

FIG. 7 shows an exemplary scanning photolithography apparatus 100 according to an embodiment of the invention.

Referring to FIG. 7, a light is radiated from a pulse light source 101 and passed through a beam shaping optical system 102, a fly eye lens 103, a condenser lens 104 and a fixed field stop (i.e., a reticle blind) 105, and then reaches a movable blind 107. Fixed field stop 105 may form a slit-shaped opening with a finely formed, long rectangle. Accordingly, light passing through fixed field stop 105 is altered from a cross-section shape to a rectangular shape (i.e., slit light) and is then projected to a relay lens system 108.

In one embodiment, movable blind 107 includes two light shielding plates 107a and 107b that define the width of the scanning direction (i.e., the first direction), and two light-shielding plates (not shown) that define the width of a direction perpendicular to the scanning direction (i.e., the second direction). Light-shielding plates 107a and 107b may be respectively driven by drive units 106a and 106b.

A pattern image on the reticle (R) placed in an illuminating region 121 is defined by movable blind 107. The pattern image is projected onto a wafer (W) via a projection optical system 113. A reticle stage 109 may be driven by a reticle driving unit 110 in order to move reticle (R) in the scanning direction, and movable blind 107 as driven by drive units 106a and 106b under control of a control unit 111, is synchronized with the scanning of reticle (R).

The wafer (W) is disposed on a wafer stage 114. Wafer stage 114 is synchronized with the scanning of reticle (R) by the movement of a wafer driving unit 115 and moves wafer (W) in a direction opposite to the scanning direction. As such, reticle (R) and wafer (W) are synchronously scanned relative to each other, and thus a projection image of the reticle pattern is sequentially transferred to each shot region on wafer (W).

A main control unit 112 may be adapted to control the control unit 111, reticle driving unit 110, and wafer driving unit 115, so that the reticle and wafer move in synchronization with each other.

The movement speed of reticle (R), according to one embodiment of the invention, may be controlled to be slower than the conventional technique. For example, a movement speed ratio between reticle (R) and wafer (W) may not be 4 to 1, but 2 to 1. Accordingly, reticle driving unit 110, which drives reticle stage 109, may be constituted so that a driving speed is not fixed and may be variously controlled by an enlargement ratio associated with reticle (R). Thus, in the context of the illustrated embodiment, if the enlargement ratio associated with the scanning direction of reticle (R) is changed to a ratio other than 2 to 1, the movement speed of reticle (R) must also be changed. A drive speed for wafer driving unit 115 may also be variably changed according to a change in an enlargement ratio (i.e., a transfer magnification).

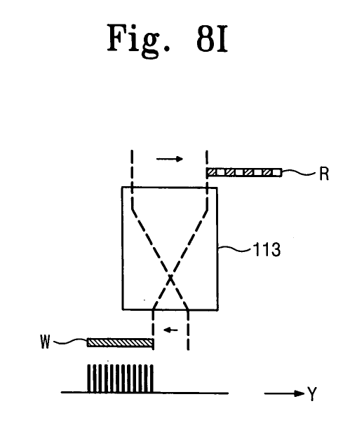

FIGS. 8A to 8I illustrate views a scanning photolithography method using a reticle according an embodiment of the invention.

Referring to FIG. 8A to 8I, when light passes through reticle (R) and is projected on wafer (W) via projection optical system 113, reticle (R) and wafer (W) move in opposite directions from each other. The indicated dosage represents a total amount of exposure light radiated on wafer (W).

As compared with the convention technique, reticle (R) according to an embodiment of the invention, has a pattern that the enlargement ratios associated with the first and second directions are different from each other. For example, the reticle pattern may have an enlargement ratio of 2 to 1 in a scanning direction (i.e., the first direction) and an enlargement ratio of 4 to 1 in a direction perpendicular to the scanning direction (i.e., the second direction). The illustrated reticle (R) represents one shot region, and has 12 chips which is more than a comparable number allowed by the conventional technique. Since the enlargement ratio of the reticle pattern to the circuit pattern is 2 to 1, reticle (R) may be moved at a speed two times greater than wafer (W).

According to the conventional technique, six chips are exposed by the one-shot using a normal reticle, and the scan field is restricted to 26 mm by 33 mm according to a corresponding lens size. However, in an embodiment according to the invention, the scan field may be expanded to 26 mm by 66 mm, enough to simultaneously expose twelve chips by the one-shot.

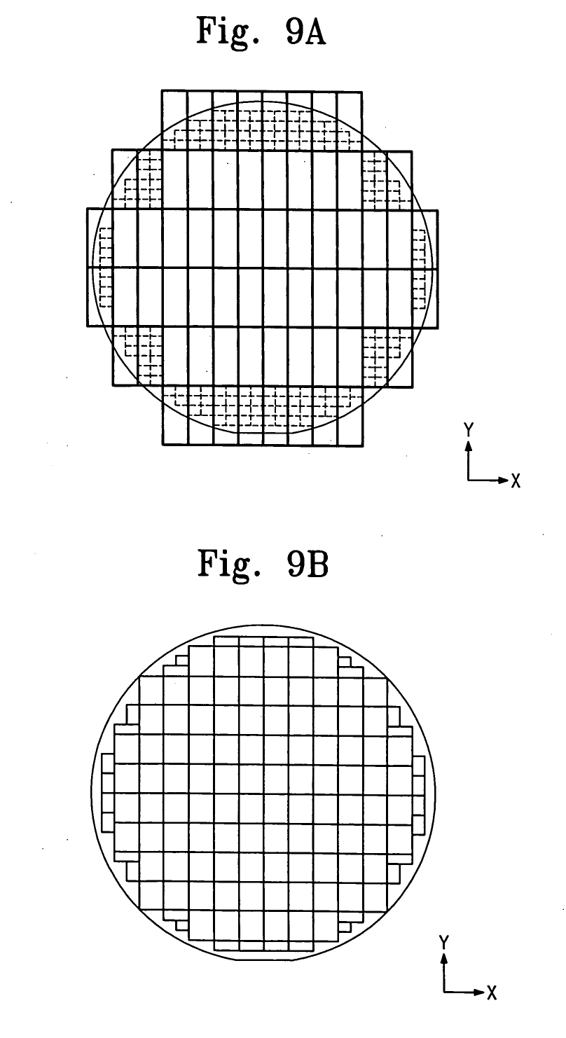

FIGS. 9A and 9B show an exemplary 300 mm wafer onto which chips are exposed by a normal reticle and a reticle for a storage node poly in a DRAM, respectively.

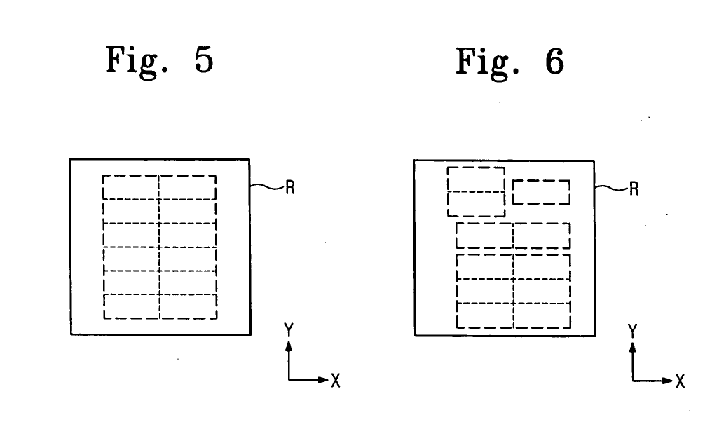

Referring to FIGS. 4A and 9A, one rectangle represents a scan field exposed by the one-shot. A dotted line represents chips formed on the edge portion of the wafer. Using the conventional technique and a normal reticle, 122 shots are required to expose the entire surface of the 300 mm wafer. However, according to the illustrated embodiment, only 68 shots are required to similarly expose the entire surface of the 300 mm wafer. Accordingly, in the comparative examples, the number of shots is reduced by 54 over the conventional technique.

Referring to FIGS. 4B and 9B, in the case of the storage node poly reticle according to the conventional technique, 366 shots are required to expose the entire surface of the 300 mm wafer. However, according to the illustrated embodiment of the invention, only 132 shots are required to expose the 300 mm wafer. Accordingly, the number of shots is reduced by 168.

As a result, according to exemplary embodiments of the present invention, the throughput may be improved by about 15˜17% in case of the normal reticle and about 200% in case of the reticle of storage node poly in the DRAM.

As described above, the movement speed of the reticle stage in embodiments of the invention may be slower than the conventional technique, thereby allowing better control over movement of the reticle stage. Additionally, as the enlargement ratio of the scanning direction of the reticle becomes smaller than that of the conventional technique, the number of shots and exposure time are greatly decreased, thereby allowing an increase in throughput.

It will be understood by those of ordinary skill in the art that various replacements, modifications and changes in form and detail may be made to the foregoing examples without departing from the scope of the present invention as defined by the following claims.

What is claimed is:

1. A scanning photolithography apparatus, comprising:
an optical system adapted to generate a slit light;
a reticle having a reticle pattern adapted to form a circuit pattern on a substrate;
a reticle driving unit configured to move the reticle in a first direction;
a projection optical system adapted to project an image of the reticle pattern onto the substrate; and
a substrate driving unit adapted to move the substrate in a direction opposite the first direction,
wherein a transfer magnification for the circuit pattern associated with the first direction is different than a transfer magnification for the circuit pattern associated with a second direction perpendicular to the first direction.

2. The photolithography apparatus of claim 1, wherein the transfer magnification associated with the first direction is less than that associated with the second direction.

3. The photolithography apparatus of claim 2, wherein the transfer magnification associated with the first direction is 1/2, and the transfer magnification associated with the second direction is 1/4.

4. The photolithography apparatus of claim 1, wherein movement speed for the reticle is defined in relation to the transfer magnification associated with the first direction.

5. The photolithography apparatus of claim 4, wherein a movement speed ratio between the reticle and the substrate is identical with respect to the transfer magnification associated with the first direction.

6. A photolithography method, comprising:
preparing a substrate and a reticle having a reticle pattern;
passing light through the reticle while moving the reticle in a first direction and simultaneously moving the substrate in a direction opposite the first direction to thereby transfer a pattern image associated with the reticle pattern onto the substrate;
wherein a transfer magnification for the pattern image associated with the first direction is different from that associated with a second direction perpendicular to the first direction.

7. The method of claim 6, wherein the transfer magnification associated with the first direction is less than that associated with the second direction.

8. The method of claim 6, wherein movement of the reticle is defined in relation to the transfer magnification associated with the first direction.

9. The method of claim 8, wherein a movement speed ratio between the reticle and the substrate is identical with respect to transfer magnification associated with the image pattern.

10. A reticle mounted with a scanning photolithography apparatus and having a reticle pattern adapted to form a circuit pattern on a photoresist layer formed on a substrate, wherein an enlargement ratio for an image pattern associated with the circuit pattern in a scanning direction defined by the scanning photolithography apparatus is different from that associated with a direction perpendicular to the scanning direction.

11. The reticle of claim 10, wherein the image pattern corresponds to an even number of chips in the scanning direction.
